(19) United States
(12) Patent Application Publication
(10) Pub. No.: US 2017/0337114 A1
(43) Pub. Date: Nov. 23, 2017

(54) SYSTEM AND METHOD FOR COMMUNICATION BETWEEN A DEBUGGER AND A TARGET PROCESSOR

(71) Applicant: VeriSilicon Holdings Co., Ltd, Plano, TX (US)

(72) Inventors: John M. Lu, Plano, TX (US); S. Prasad Kalluri, Richardson, TX (US); Adam C. Krolnik, Wylie, TX (US)

(21) Appl. No.: 15/159,991

(22) Filed: May 20, 2016

(51) Int. Cl. G06F 11/36

(52) U.S. Cl. CPC G06F 11/3636; G06F 11/3664

(57) ABSTRACT

A system for, and method of, allowing a debugger to debug application software executing on a target processor and a system for communication between a debugger associated with a host system and a target processor associated with a target system. In one embodiment, the former system includes: (1) debug probe hardware coupled to the target processor and couplable to a host system associated with the debugger and (2) an encryption/decryption block associated with the target processor and configured to decrypt encrypted commands and data received from the debugger and encrypt the data to be transmitted to the debugger for decryption by the host system.

### TECHNICAL FIELD

This application is directed, in general, to a computer application development and, more specifically, to a system and method for effecting communication between a debugger and the target processor on which an application being developed is executing.

### BACKGROUND

When debugging an application developed for a given, “target,” processor, it is common to use two systems: a host system in which a debugger executes, and a target system in which the application executes on the target processor. Debug probe hardware couples the host system and the target system and allows communication to take place between the two systems.

Commands to communicate with the target system are communicated from the debugger over a general-purpose serial communication interface, such as a Universal Serial Bus (USB) interface, to the debug probe hardware. The debug probe hardware, in turn, generates signaling to communicate over a standard testing interface, such as a Joint Test Action Group (JTAG) or Serial Wire Debug (SWD) interface, to debug circuitry associated with the target processor. In some implementations, the target system includes the debug probe hardware, in which case communication from the host system to the target system is purely by way of the general-purpose serial communication interface.

Commands or data values from the debugger need to be processed before the debug circuitry of the target processor can handle them. One way to do this is to use software called “debug monitor code” (DMC) executing on the target processor. The DMC examines bits presented in registers in the debug circuitry and determines the command to execute or the data to update. The DMC also uses the debug circuitry to acknowledge the commands or transfer data back to the debugger as necessary via the debug probe hardware. The debugger is able to display to a user data it has received from the debug circuitry of the target processor. Given this debug arrangement, it is possible to query the state of the target processor or the contents of its memory and gain detailed knowledge about the execution of the application.

### SUMMARY

One aspect provides a system for allowing a debugger to debug application software executing on a target processor. In one embodiment, the former system includes: (1) debug probe hardware coupled to the target processor and couplable to a host system associated with the debugger and (2) an encryption/decryption block associated with the target processor and configured to decrypt encrypted commands and data received from the debugger and encrypt the data to be transmitted to the debugger for decryption by the host system.

Another aspect provides a method of allowing a debugger to debug application software executing on a target processor. In one embodiment, the method includes: (1) receiving an encrypted command from the debugger into debug probe hardware coupled to the target processor, (2) decrypting the encrypted command, (3) responding to the decrypted command and (4) encrypting data reflecting the responding for transmission to the debugger.

Yet another aspect provides a system for communication between a debugger associated with a host system and a target processor associated with a target system. In one embodiment, the system includes: (1) debug probe hardware coupling the host system and the target system, (2) an encryption/decryption block associated with the debugger and configured to encrypt commands and data transmitted from the debugger through the debug probe hardware to the target system and decrypt data to be received by the debugger through the debug probe hardware and (3) an encryption/decryption block associated with the target processor and configured to decrypt the commands and data transmitted from the debugger and encrypt the data to be received by the debugger.

### BRIEF DESCRIPTION

Reference is now made to the following descriptions taken in conjunction with the accompanying drawings, in which:

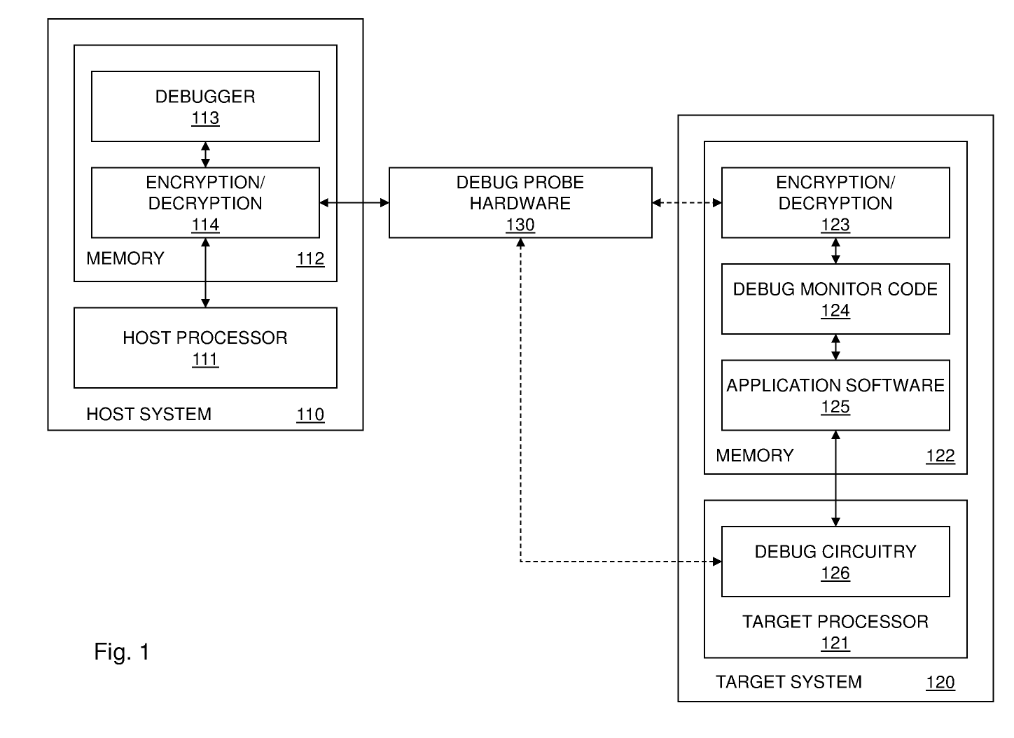

FIG. 1 is a block diagram of one embodiment of a debug arrangement having an enhanced security; and

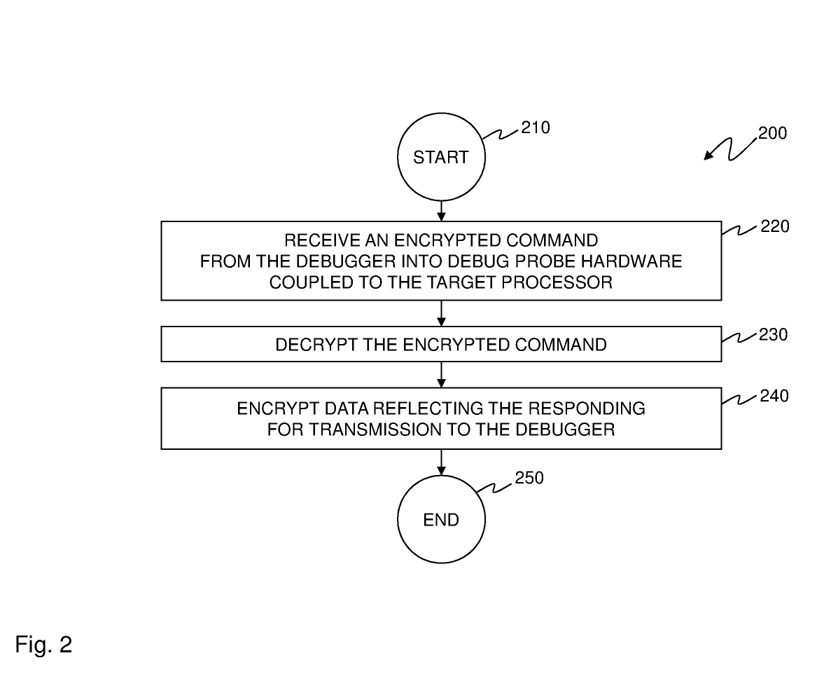

FIG. 2 is a flow diagram of one embodiment of a method of communication between a debugger and a target processor.

### DETAILED DESCRIPTION

As stated above, the debug mechanism described in the Background allows the state of the target processor or the contents of its memory to be queried, yielding detailed knowledge about the execution of the application executing on the target processor. However, it is realized herein that this conventional and widely-used technique for developing applications carries with it a subtle, but potentially serious, security issue. More specifically, it is realized herein that a person bent on mischief or crime may use a debugger and probe to examine a given application not to improve it but instead identify its vulnerabilities, and perhaps its flaws, which then may be exploited in a subsequent attack.

Introduced herein are various embodiments of a system and method for communication between a debugger and a target processor that address this security issue. The various embodiments apply various forms of encryption to the communication, making unauthorized access to debugging information more difficult.

FIG. 1 is a block diagram of one embodiment of a debug arrangement having an enhanced security. The debug arrangement involves a host system 110 and a target system 120.

The host system 110 includes a host processor 111 and memory 112. The host processor 111 may be of any conventional or later-developed manufacture, model or type, such as a microprocessor or a microcontroller or a “cloud” processor (one or more processors of one or more arbitrary types accessible via a network such as the Internet). Likewise, the memory 112 may be of any conventional or later-developed manufacture, model or type. Various embodiments of the memory 112 feature volatile and nonvolatile memory including random-access memory (RAM), read-only memory (ROM), programmable ROM (PROM) electronically erasable PROM, sometimes called “flash memory”), hard-drive memory or “cloud” memory (memory of one or more arbitrary types accessible via a network such as the Internet).

Stored in the memory 112 for execution by the host processor 111 are a debugger 113 and encryption/decryption block 114. As those skilled in the art understand, a debugger is a software tool that aids in the identification, characterization and repair of errors or faults (“bugs”) in a computer software program of some type, herein termed “application software.” To this end, the debugger 113 typically issues commands that cause the application software to operate with respect to data and analyzes the manner in which the application software operates on the data, typically by examining the data after the software application has operated on it. Although not required, the debugger 113 may provide the data on which the application software operates.

The encryption/decryption block 114 is an entity that transforms “plaintext” into “ciphertext” by applying to the plaintext an encryption algorithm including one or more mathematical and/or logical operations and transforms the ciphertext back into plaintext by applying to the ciphertext a decryption algorithm including one or more mathematical and/or logical operations to it. In the illustrated embodiment, the decryption algorithm is the inverse of the encryption algorithm, resulting in what those skilled in the pertinent art call a symmetrical algorithm. Although some embodiments employ secret (not publicly known) algorithms, those skilled in the pertinent art understand that one typically does not rely on the secrecy of the algorithms themselves. Therefore, many embodiments employ algorithms that are, or are assumed to be, publicly known, but rely on a key that is kept secret and typically unique to each target system 120. Depending upon the encryption technique being employed, the algorithms use a codebook in addition to a key; the codebook is kept secret and typically unique to each target system 120. Those skilled in the pertinent art are familiar with a host of conventional encryption and decryption techniques. While the embodiments described herein encompass all conventional and later-developed encryption and decryption techniques, an introduction to and discussion of those techniques is outside the scope of this disclosure and unnecessary to those skilled in the pertinent art.

Though the encryption/decryption block 114 takes the form of software (being stored in the memory 112) in the illustrated embodiment, other embodiments of the encryption/decryption block 114 are or include hardware and thus may not be stored wholly or in part in the memory 112.

As those skilled in the art aware, encryption/decryption block is typically regarded as a “black box,” i.e., plaintext goes in one end and eventually comes out the other; ciphertext is generated, communicated and used in the interim, but no particular need exists to understand the cryptographic processes that the encryption/decryption block 114 is carrying out. Accordingly, in the illustrated embodiment, the debugger 113 needs no substantial modification to pass plaintext commands and data to, and receive plaintext data from, the encryption/decryption block 114. In certain embodiments, the debugger 113 needs no modification whatsoever.

The target system 120 includes a target processor 121 and memory 122. The target processor 121 may be of any conventional or later-developed manufacture, model or type. In the illustrated embodiment, the target processor 121 is a microprocessor. In alternative embodiments, the target processor 121 is a microcontroller or a programmable gate array (PGA). Likewise, the memory 122 may be of any conventional or later-developed manufacture, model or type. Various embodiments of the memory 122 feature volatile and nonvolatile memory including random-access memory (RAM), read-only memory (ROM), programmable ROM (PROM) electronically erasable PROM, sometimes called “flash memory”) or hard-drive memory.

Stored in the memory 122 for execution by the target processor 121 are encryption/decryption block 123, DMC 124 and application software 125. The encryption/decryption block 123 is a counterpart to the encryption/decryption block 114 in that the encryption/decryption block 123 is configured to decrypt commands and data which the encryption/decryption block 114 has encrypted and encrypt data for decryption by the encryption/decryption block 114.

Though the encryption/decryption block 123 takes the form of software (being stored in the memory 122) in the illustrated embodiment, other embodiments of the encryption/decryption block 123 are or include hardware and thus may not be stored wholly or in part in the memory 122.

The DMC 124 is a companion to the debugger 113 and therefore capable of interacting with debug circuitry 126 associated with the target processor 121 to relay commands issued by the debugger 113 and convey data from the debugger 113 that operates as input data for debugging purposes and convey data reflecting the operation of the application software 125 back to the debugger 113. The application software 125 has been developed and is the subject of the debugging that is to take place with the arrangement of FIG. 1.

In the illustrated embodiment, the target processor 121 includes debug circuitry 126. The debug circuitry 126 allows access to various parts of the target processor 121 to enable data to be written to and read from registers (not shown) in the target processor 121 and commands to be executed to begin, pause, resume and end execution of the application software 125 on the target processor 121. Those skilled in the pertinent art are familiar with the structure and content of debug circuitry.

Finally, FIG. 1 illustrates debug hardware 130 coupling the host system 110 and the target system 120. The debug probe hardware 130 is responsible for intervening in and handling the communication of commands and data from the host system 110 to the target system 120 and communicating data back to the host system 110 from the target system 120. In conventional arrangements, the debug probe hardware 130 receives commands and data directly from the debugger 113 in plaintext. In the arrangement of FIG. 1, the debug probe hardware 130 instead receives commands and data in ciphertext from the debugger 113 through the encryption/decryption block 114.

The encryption/decryption block 114 transmits commands and data to the debug probe hardware 130 and receives data from the debug probe hardware over a general-purpose serial communication interface, such as a USB interface. Other embodiments employ alternative serial communication interfaces, such as Ethernet and FireWire, to communicate commands and data. The debug probe hardware 130 generates signaling to communicate with the target system 120 over a standard testing interface, such as a JTAG or SWD interface, to debug circuitry associated with the target processor.

The arrangement of FIG. 1 illustrates two alternative embodiments for the debug probe hardware 130 with respect to the target system 120. In a first alternative embodiment, the debug probe hardware 130 is external to the target system 120. In a second alternative embodiment, the target system 120 includes the debug probe hardware 130. Broken lines extending from the debug probe hardware 130 to the encryption/decryption block 123 and from the debug probe hardware 130 to the debug circuitry 126 are intended to symbolize these two alternative embodiments. Irrespective of the embodiment, commands and data to and from the debug probe hardware 130 are routed through the encryption/decryption software 123.

In one embodiment, the encryption/decryption software 114 and the encryption/decryption software 123 employ a proprietary encryption algorithm that is known only to a legitimate developer of the application software 125 and thus limits misuse by anyone else. However, this may not be suitably efficient for widespread use of the arrangement disclosed herein, because a manufacturer of a given target processor 121 usually provides a corresponding debugger 113, debug circuitry 126, DMC 124 and debug probe hardware 130 to its customers and cannot easily create unique versions of these for each customer.

For this reason, the illustrated embodiment employs an encryption algorithm that is common to multiple target systems, but also key that is unique to each target system. The encryption algorithm could be as simple as an exclusive OR (XOR) logic function or something more elaborate, implemented in hardware and/or software. The target processor has access to the unique key, giving the encryption/decryption block 123 access to it as well. Likewise, the host processor 111 would have access to another copy of the same unique key, giving the encryption/decryption block 114 access to it as well. In various embodiments, the unique key is accessible via an input/output (I/O) port, a memory port, a coprocessor port or an internal register associated with the target processor 121 and the host processor 111. With the unique key, the encryption/decryption block 114 and the encryption/decryption block 123 can encrypt and decrypt each other's ciphertext successfully.

The arrangement of FIG. 1 may operate to effect debugging of the application software 125 executing on the target processor 121 as follows. First, a user (not shown) prompts the debugger 113 to cause certain data to be stored in one or both of the target processor 121 or the memory 122 of the target system 120. Accordingly, the debugger 113 transmits the data (in plaintext) to the encryption/decryption block 114, where it is encrypted and transmitted in encrypted form to the debug probe hardware 130. The debug probe hardware 130 then transmits the encrypted data to the target processor 121, where it is decrypted by the encryption/decryption block 123 and stored in the target processor 121 or memory 122 as directed by the debug circuitry 126. Then, the user prompts the debugger 113 to generate a command to begin execution of the application software 125 on the target processor. Accordingly, the debugger 113 transmits the command (in plaintext) to the encryption/decryption block 114, where it is encrypted and transmitted in encrypted form to the debug probe hardware 130. The debug probe hardware 130 then may transmit the encrypted command to the target processor 121, where it is decrypted by the encryption/decryption block 123 and used to instruct the target processor 121 to begin execution of the application software 122. In an alternative embodiment, the debug probe hardware 130 decrypts the command and provides it in plaintext to the target processor 121.

Should the user wish to pause execution of the application software 125, or should execution of the application software end on its own, the user causes the debugger 113 to issue a command to read the data. Accordingly, the encryption/decryption block 114 encrypts the command, the debug probe hardware 130 transmits the command, and the encryption/decryption block 123 decrypts the command, allowing the DMC 124 to read the data from the target processor 121 and/or the memory 122. The encryption/decryption block 123 then encrypts the data, and the debug probe hardware 130 transmits the data back to the debugger 113, where the encryption/decryption block 114 intercepts and decrypts it into plaintext form for display by the debugger 113 to the user.

FIG. 2 is a flow diagram of one embodiment of a method 200 of communication between a debugger and a target processor. The method 200 begins in a start step 210. In a step 220, an encrypted command is received from the debugger into debug probe hardware coupled to the target processor. Data may also be received from the debugger, in which case the data is encrypted as well. In a step 230, the encrypted command (and any data received along with the command) is decrypted. The command is then handled. The handling may involve interacting with application software in some way, including executing the application software or pausing, resuming or stopping the execution. Irrespective of the nature of the command, some response results from the command. Thus, in a step 240, data reflecting the responding to the command is encrypted for transmission to the debugger. The method 200 ends in a step 260.

Those skilled in the art to which this application relates will appreciate that other and further additions, deletions, substitutions and modifications may be made to the described embodiments.

What is claimed is:

1. A system for allowing a debugger to debug application software executing on a target processor, comprising:
debug probe hardware coupled to said target processor and couplable to a host system associated with said debugger; and
an encryption/decryption block associated with said target processor and configured to decrypt encrypted commands and data received from said debugger and encrypt said data to be transmitted to said debugger for decryption by said host system.

2. The system as recited in claim 1 wherein a target system including said target processor excludes said debug probe hardware.

3. The system as recited in claim 1 wherein a target system including said target processor includes said debug probe hardware.

4. The system as recited in claim 1 wherein said encryption/decryption block is configured to employ an encryption algorithm that is common to multiple target systems.

5. The system as recited in claim 1 wherein said encryption/decryption block is configured to employ a secret key unique to said target system and employable by said host system.

6. The system as recited in claim 1 further comprising debug monitor code configured to interact with debug circuitry of said target processor to relay said commands and convey said data between said debugger and said target processor.

7. The system as recited in claim 1 wherein said encryption/decryption block is a sequence of software instructions storable in a memory coupled to said target processor.

8. A method of allowing a debugger to debug application software executing on a target processor, comprising:
receiving an encrypted command from said debugger into debug probe hardware coupled to said target processor;
decrypting said encrypted command;
responding to said decrypted command; and
encrypting data reflecting said responding for transmission to said debugger.

9. The method as recited in claim 8 wherein a target system including said target processor excludes said debug probe hardware.

10. The method as recited in claim 8 wherein a target system including said target processor includes said debug probe hardware.

11. The method as recited in claim 8 wherein said decrypting and said encrypting are carried out employing an encryption algorithm that is common to multiple target systems.

12. The method as recited in claim 8 wherein said decrypting and said encrypting are carried out employing a secret key unique to said target system and employable by said host system.

13. The method as recited in claim 8 further comprising employing debug monitor code to interact with debug circuitry of said processor to relay said command and convey said data between said debugger and said target processor.

14. The method as recited in claim 8 wherein said decrypting and said encrypting are carried out using a sequence of software instructions storable in a memory coupled to said target processor.

15. A system for communication between a debugger associated with a host system and a target processor associated with a target system, comprising:
debug probe hardware coupling said host system and said target system;
an encryption/decryption block associated with said debugger and configured to encrypt commands and data transmitted from said debugger through said debug probe hardware to said target system and decrypt data to be received by said debugger through said debug probe hardware; and
an encryption/decryption block associated with said target processor and configured to decrypt said commands and data transmitted from said debugger and encrypt said data to be received by said debugger.

16. The system as recited in claim 15 wherein said target system includes said debug probe hardware.

17. The system as recited in claim 15 wherein said encryption/decryption blocks are configured to employ an encryption algorithm that is common to multiple target systems.

18. The system as recited in claim 15 wherein said encryption/decryption blocks are configured to employ a secret key unique to said target system and employable by said host system.

19. The system as recited in claim 15 wherein said target system further includes debug monitor code configured to interact with debug circuitry of said target processor to relay said commands and convey said data between said debugger and said target processor.

20. The system as recited in claim 15 wherein said encryption/decryption block is a sequence of software instructions storable in a memory coupled to said target processor.
